(19) United States
(12) Patent Application Publication
(10) Pub. No.: US 2014/0233988 A1
(43) Pub. Date: Aug. 21, 2014

(54) IMAGE FORMING APPARATUS

(71) Applicant: CANON KABUSHIKI KAISHA, Tokyo (JP)

(72) Inventor: Shoji Kanemura, Sagamihara-shi (JP)

(73) Assignee: CANON KABUSHIKI KAISHA, Tokyo (JP)

(21) Appl. No.: 14/182,792

(22) Filed: Feb. 18, 2014

(30) Foreign Application Priority Data
Feb. 19, 2013 (JP) 2013-029571

(51) Int. Cl. G03G 15/01

(52) U.S. Cl. CPC G03G 15/043
USPC 399/301

(57) ABSTRACT

A control portion of an image forming apparatus controls an exposure unit and a developing unit to form misregistration inspecting toner images at both end portions and a center portion of a photoconductive drum and transfers the toner images to an intermediate transfer belt. Then, the control portion detects a misregistration amount of each toner image by misregistration detecting sensors to obtain position information in a main scanning direction per each phase position in which the scanning exposure has been performed on the image carrier. The control portion corrects detection results of the detecting sensors at the both end portions by removing an axial moving amount within a rotation cycle of the photoconductive drum on a basis of a detection result of the misregistration detecting sensor at the center portion.

### BACKGROUND OF THE INVENTION

1. Field of the Invention

The present invention relates to an image forming apparatus capable of transferring a toner image formed on an image carrier by performing scanning exposure on the image carrier to a belt member.

2. Description of the Related Art

An image forming apparatus configured to transfer a toner image formed on an image carrier by performing scanning exposure on the image carrier to a recording medium by using a belt member and fixing the image to the recording medium by heating and pressing the recording medium on which the toner image has been transferred is widely used. If the image carrier rotates eccentrically (in parallel and obliquely) in the image forming apparatus configured to perform the scanning exposure on the image carrier, a range on which the scanning exposure is performed on the image carrier fluctuates in a main scanning direction, causing misregistration and distortion of the toner images in the main scanning direction.

Japanese Patent Application Laid-open No. H10-153896 is configured to form continuous and linear misregistration inspecting toner images at one and other ends of an image carrier, to transfer the toner images to a belt member, and to be able to execute a measuring mode of detecting a positional fluctuation in the main scanning direction of the misregistration inspecting toner image on the belt member. Then, the image forming apparatus extracts cyclic positional fluctuations of the image carrier from the positional fluctuation in the main scanning direction of the misregistration inspecting toner images. In forming an image, the image forming apparatus cancels the cyclic positional fluctuations of the image carrier by adjusting an expansion/contraction ratio in the main scanning direction of the image in each position in a rotation direction of the image carrier and a position in the main scanning direction of the image on a basis of the extraction result.

Japanese Patent Application Laid-open No. 2001-265081 discloses an intermediate transfer type image forming apparatus configured to transfer a toner image formed on an image carrier to an intermediate transfer drum. Here, the image forming apparatus executes a so-called slip and transfer control by setting a predetermined circumferential speed difference between the image carrier and the intermediate transfer drum. Japanese Patent Application Laid-open No. 2009-17396 discloses a control on a magnification in a main scanning direction of an image written on an image carrier, i.e., a control on an expansion/contraction ratio of a scanning line corresponding to a rotational phase position of the image carrier.

It is found that the misregistration in the main scanning direction and the distortion of an image formed on the image carrier and transferred to the belt member are caused also by factors other than the eccentric rotation of the image carrier as described in Japanese Patent Application Laid-open No. H10-153896. The misregistration occurs in the image formed on the image carrier as the image carrier cyclically axially moves (thrust move) due to fluctuations of a thrust force (fluctuations of a surface pressure of a driving gear surface for example) acting on the image carrier from a driving system and a supporting system of the image carrier.

A fluctuation amount of the cyclic axial move of the image carrier can be detected by using a continuous and linear misregistration inspecting toner image as described in Japanese Patent Application Laid-open No. H10-153896. However, because the cyclic axial move of the image carrier does not accompany such changes of magnification in the main scanning direction of the image that is caused by the eccentric rotation, the method of changing the magnification of the image in the main scanning direction as described in Japanese Patent Application Laid-open No. H10-153896 may cause a distortion in the image by unnecessary correcting the image. In a case where the eccentric rotation and the axial move occur in the image carrier in the same time in particular, the misregistration in the main scanning direction and an expansion and contraction deformation remain significantly in the image outputted after such correction.

### SUMMARY OF THE INVENTION

According to an aspect of the present invention, an image forming apparatus includes an image carrier, an exposure unit configured to form an electrostatic image by performing scanning exposure of a laser beam to the image carrier, a developing unit configured to develop the electrostatic image and to form a toner image on the image carrier, a plurality of support rotating bodies, a belt member being in contact with the image carrier by being stretched by the plurality of support rotating bodies such that the toner image can be transferred to the belt member from the image carrier, a first detection portion detecting a position of the toner image transferred to one end portion of the belt member in a direction orthogonal to a moving direction of the belt member, a second detection portion detecting a position of the toner image transferred to another end portion of the belt member in the direction orthogonal to the moving direction of the belt member, a third detection portion detecting a position of the toner image transferred to a center portion of the belt member in the direction orthogonal to the moving direction of the belt member, and a control portion configured to prepare exposure control information correcting an exposure position in a main scanning direction which is a scanning direction of the laser beam per phase position in a sub-scanning direction which is a rotation direction of the image carrier, the control portion having a measuring mode of forming misregistration inspecting toner images at both end portions and a center portion of the image carrier by controlling the exposure unit and the developing unit, of transferring the misregistration inspecting toner images to the belt member, and of detecting the misregistration inspecting toner images by the first, second and third detection portions to obtain position information in the main scanning direction per each phase position in the sub-scanning direction, and preparing the exposure control information from detection results of the first and second detection portions in which an axial moving amount within a rotation cycle of the image carrier is removed on a basis of a detection result of the third detection portion in the measuring mode.

Further features of the present invention will become apparent from the following description of exemplary embodiments (with reference to the attached drawings).

### BRIEF DESCRIPTION OF THE DRAWINGS

FIG. 1 is a schematic diagram explaining a configuration of an image forming apparatus.

FIG. 2 is a schematic diagram explaining a configuration of an image forming portion.

FIG. 3 is a schematic diagram explaining a configuration of an exposure unit.

FIG. 4 is a schematic diagram explaining disposition of a misregistration detecting sensor.

FIG. 5A is a schematic diagram showing a color shift inspecting pattern in a case where a photoconductive drum is not eccentric.

FIG. 5B is a schematic diagram showing a color shift inspecting pattern in a case where the photoconductive drum is eccentric.

FIG. 6A is a schematic diagram showing a color shift inspecting pattern in a case where the photoconductive drum generates a thrust shift.

FIG. 6B is a schematic diagram showing a color shift inspecting pattern in a case where the photoconductive drum is eccentric and causes a thrust shift.

FIG. 7 is a diagram illustrating a method for detecting a cyclic movement caused by swing rotation.

FIG. 8 is a diagram illustrating an influence of an axial fluctuation at each position in a main scanning direction.

FIG. 9A is a diagram illustrating the color shift inspecting patterns transferred to an intermediate transfer belt.

FIG. 9B is a diagram illustrating the color shift inspecting patterns when the photoconductive drum causes the axial fluctuation and the eccentric rotation.

FIG. 10 is a block diagram of a control system in the image forming apparatus of a first embodiment.

FIG. 11 is a flowchart of a control for updating a correction table in the first embodiment.

FIG. 12 is a flowchart of a control for detecting the color shift inspecting pattern of each color.

FIG. 13 is a diagram illustrating an output of an encoder.

FIG. 14 is a diagram illustrating image data of cyclic positional fluctuations in the main scanning direction.

FIG. 15 is a graph illustrating a relationship between an eccentric rotational amount and an incident angle of a laser beam.

FIG. 16 is a diagram illustrating a disposition of a color shift inspecting pattern of a second embodiment.

FIG. 17 is an enlarged view of the color shift inspecting pattern.

### DESCRIPTION OF THE EMBODIMENTS

Embodiments of the present invention will be explained in detail below with reference to the drawings.

### First Embodiment

### <Image Forming Apparatus>

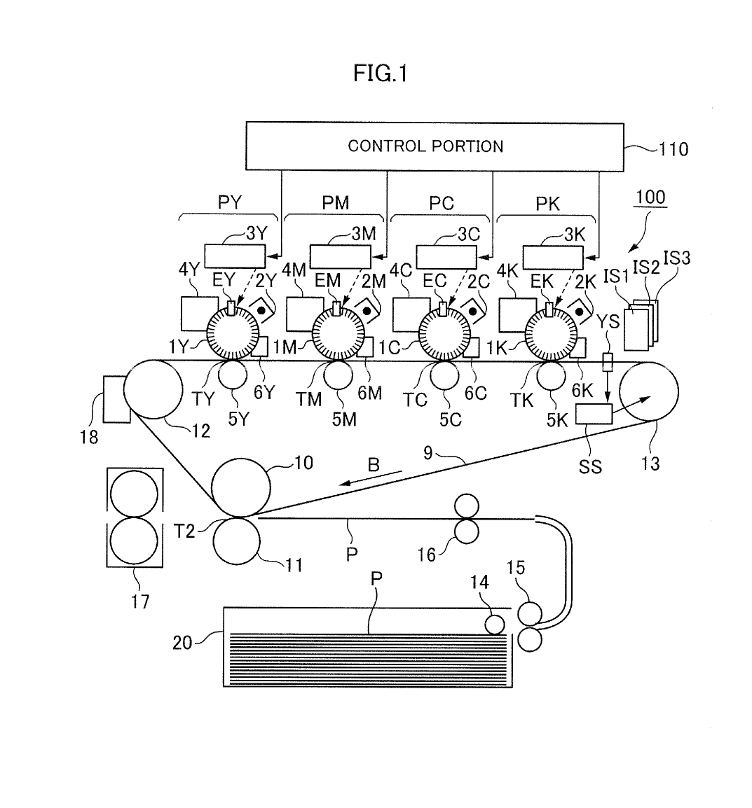

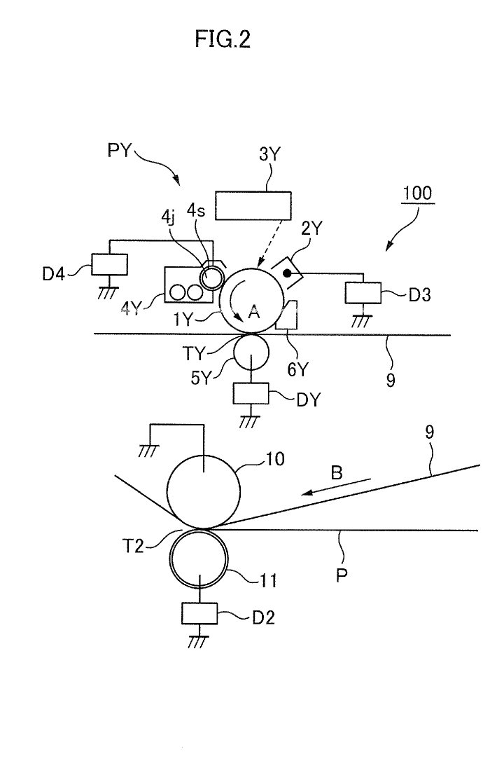

FIG. 1 is a schematic diagram explaining a configuration of an image forming apparatus 100 and FIG. 2 is a schematic diagram explaining a configuration of an image forming portion. As shown in FIG. 1, an exposure unit 3Y forms an electrostatic image by performing scanning exposure of a laser beam on a photoconductive drum 1Y which is one exemplary image carrier. A developing unit 4Y develops the electrostatic image and forms a toner image on the photoconductive drum 1Y. An intermediate transfer belt 9 which is one exemplary belt member is stretched around a driving roller 10 and others which are one example of a plurality of support rotating bodies and is capable of transferring the toner image from the photoconductive drum 1Y.

A misregistration detecting sensor IS1 which is one exemplary first detecting portion can detect a position of the toner image transferred at one end in a direction orthogonal to a moving direction of the intermediate transfer belt 9. A misregistration detecting sensor IS3 which is one exemplary second detecting portion can detect a position of the toner image transferred to another end in the direction orthogonal to the moving direction of the intermediate transfer belt 9. A misregistration detecting sensor IS2 which is one exemplary third detecting portion can detect a position of the toner image transferred to a center part in the direction orthogonal to the moving direction of the intermediate transfer belt 9.

As shown in FIG. 1, the image forming apparatus 100 is a full-color laser beam printer in which image forming portions PY, PM, PC, and PK of yellow, magenta, cyan, and black are disposed along the intermediate transfer belt 9.

In the image forming portion PY, a yellow toner image is formed on the photoconductive drum 1Y and is transferred to the intermediate transfer belt 9. In the image forming portions PM, PC, and PK, a magenta toner image, a cyan toner image and a black toner image are formed respectively on the photoconductive drums 1M, 1C and 1K and are transferred sequentially to the intermediate transfer belt 9.

The toner image transferred to the intermediate transfer belt 9 is conveyed to a secondary transfer portion T2 and is secondarily transferred to a recording medium P. The recording medium P is pulled out of a sheet feed cassette 20 by a feed roller 14 and is sent to a registration roller 16 by being separated one by one by a separating unit 15. The registration roller 16 feeds the recording medium P to the secondary transfer portion T2 by matching a head of the recording medium P with the toner image carried on the intermediate transfer belt 9.

The recording medium P on which the toner image has been secondarily transferred is passed to a fixing unit 17 to be heated and pressed to fix a full-color image on the surface of the recording medium P. A belt cleaning unit 18 recovers the toners remaining after the transfer on the intermediate transfer belt 9 after passing through the secondary transfer portion T2.

The image forming portions PY, PM, PC, and PK have the same structure except that the toners used in the developing units 4Y, 4M, 4C and 4K are different as yellow, magenta, cyan, and black. Accordingly, the following explanation will be made by exemplifying only the yellow image forming portion PY and the image forming portions PM, PC, and PK will be explaining by replacing reference characters from Y to C, M, and K.

As shown in FIG. 2, the image forming portion PY is provided with a charging unit 2Y, the exposure unit (laser unit) 3Y, the developing unit 4Y, a primary transfer roller 5Y, and a drum cleaning unit 6Y around the photoconductive drum 1Y. The photoconductive drum 1Y is formed by coating an organic photoconductive layer (OPC) on an outer circumferential surface of an aluminum made cylinder. The charging unit 2Y charges the surface of the photoconductive drum 1Y with a homogeneous negative polarity potential. The exposure unit 3Y forms an electrostatic image corresponding to yellow image data on the photoconductive drum 1Y by performing scanning exposure on the surface of the photoconductive drum 1Y.

The developing unit 4Y charges toner to negative polarity by agitating a two-component developer in which magnetic carrier is mixed in the toner. The charged toner is carried on a developing sleeve 4s that rotates in a counter direction from the photoconductive drum 1Y around a stationary magnetic pole 4j in a napped condition and comes in slidable contact with the photoconductive drum 1Y. A power source D4 applies an oscillation voltage in which an AC voltage is superimposed to a negative polarity DC voltage to the developing sleeve 4s to adhere the toner to the electrostatic image on the photoconductive drum 1Y which becomes relatively positive more than the developing sleeve 4s to reversely develop the electrostatic image.

The primary transfer roller 5Y presses an inner side surface of the intermediate transfer belt 9 to form a primary transfer portion TY between the photoconductive drum 1Y and the intermediate transfer belt 9. The power source DY applies a transfer voltage to the primary transfer portion TY to electrically move the toner image on the photoconductive drum 1Y to the intermediate transfer belt 9. The drum cleaning unit 6Y recovers the transfer remaining toner left on the photoconductive drum 1Y after passing through the primary transfer portion TY.

A secondary transfer roller 11 is in pressure contact with the intermediate transfer belt 9 supported by a backup roller 10 and forms the secondary transfer portion T2 between the secondary transfer roller 11 and the intermediate transfer belt 9. The power source D2 applies a transfer voltage to the secondary transfer portion T2 and electrically moves the toner image on the intermediate transfer belt 9 to a recording medium conveyed to the secondary transfer portion T2 while being overlapped with the intermediate transfer belt 9.

As shown in FIG. 1, the intermediate transfer belt 9 is supported by being suspended around the backup roller 10 that also functions as a driving roller, a tension roller 12, and a steering roller 13. The backup roller 10 is driven by a driving motor not shown and rotates the intermediate transfer belt 9 in a direction of an arrow B.

A lean position sensor YS is disposed in contact with a belt edge on a rear side of the intermediate transfer belt 9, viewing from a front side in FIG. 1, to detect a lean position of the intermediate transfer belt 9. A steering control portion SS tilts the steering roller 13 corresponding to an output of the lean position sensor YS to converge a lean movement of the intermediate transfer belt 9 by moving the lean position thereof to a center. Accordingly, the intermediate transfer belt 9 travels stably during which no image is formed by being positioned at the center in a direction of a rotational axis of the steering roller 13 without tilting the steering roller 13.

### <Slip and Transfer>

A predetermined circumferential speed difference is set between the photoconductive drums 1Y, 1M, 1C, and 1K and the intermediate transfer belt 9 shown in FIG. 1. That is, a control portion 110 controls driving motors of the photoconductive drums 1Y, 1M, 1C, and 1K on a basis of outputs of encoders EY, EM, EC, and EK to control the photoconductive drums 1Y, 1M, 1C, and 1K at a constant angular velocity with variable speed. The photoconductive drums 1Y, 1M, 1C, and 1K rotate in synchronism with pulse signals of the encoders EY, EM, EC, and EK, and a phase relation of the photoconductive drums 1Y, 1M, 1C, and 1K at each time is always kept constant.

A circumferential speed of the intermediate transfer belt 9 is set to be higher than the circumferential speed of the photoconductive drums 1Y, 1M, 1C, and 1K by 0.5%. It is possible to prevent the intermediate transfer belt 9 from slackening by making the difference of speed of about 0.5% between the speeds of the photoconductive drums 1Y, 1M, 1C, and 1K and of the intermediate transfer belt 9. Still further, a widthwise move of the intermediate transfer belt 9 hardly affects the move in a rotation axis direction of the photoconductive drums 1Y, 1M, 1C, and 1K by keeping the so-called slip and transfer relationship between the photoconductive drums 1Y, 1M, 1C, and 1K and the intermediate transfer belt 9. Therefore, it is possible to reduce disturbance of the positional fluctuation in the main scanning direction of the photoconductive drums 1Y, 1M, 1C, and 1K otherwise caused through the intermediate transfer belt 9 by keeping the slip and transfer relationship. It is preferable to reduce the disturbance in a control of the present embodiment individually adjusting cyclic fluctuations of the photoconductive drums 1Y, 1M, 1C, and 1K.

### <Exposure Unit>

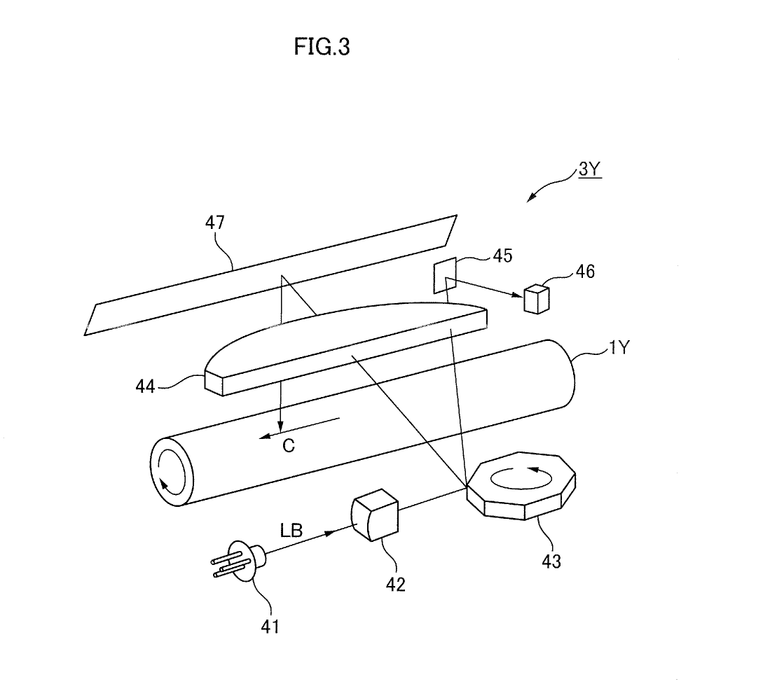

FIG. 3 is a diagram schematically illustrating a configuration of the exposure unit 3Y. As shown in FIG. 3, a semiconductor laser 41 of the exposure unit 3Y outputs a laser beam LB ON-OFF modulated in accordance to scanning line image data developing a yellow color separation image. The laser beam LB is scanned by a rotating polygon mirror 43 and is exposed to the photoconductive drum 1Y which is one exemplary image carrier to form an electrostatic image of the scanning line corresponding to the scanning line image data on the photoconductive drum 1Y. In synchronism with a rotation of the rotating polygon mirror 43, the laser beam LB is modulated to a duty ratio corresponding to density of yellow pixels to be formed on a recording medium.

The laser beam LB outputted of the semiconductor laser arrives at the rotating polygon mirror 43 through a cylindrical lens 42. The rotating polygon mirror 43 is directly rotationally driven by a motor not shown and disposed adjacent the rotating polygon mirror 43. The laser beam LB is deflected by the rotating polygon mirror 43 and transmits through an fθ lens 44. Then, scanning exposure of the laser beam LB is performed such that a beam spot moves on a surface of the photoconductive drum 1Y along a scanning line in a direction of an arrow C at constant velocity.

A part of the laser beam LB passing through the fθ lens 44 is reflected by a BD reflection mirror 45 provided in correspondence to an outside of an image region of the photoconductive drum 1Y and is inputted to a BD sensor 46. The BD sensor 46 is formed of a photo-diode and generates an output signal for use in generating an image writing start timing in the main scanning direction of the exposure unit 3Y and in detecting a rotation condition of the rotating polygon mirror 43.

The scanning exposure of the laser beam LB is performed on the photoconductive drum 1Y in the main scanning direction in the image region of the photoconductive drum 1Y to form the electrostatic image of the scanning line. The photoconductive drum 1Y rotates in a sub-scanning direction and arrays the scanning lines of the electrostatic image at equal intervals in the rotation direction of the photoconductive drum 1Y. Thus, the electrostatic image is written with a resolution of 600 dpi (dot/inch) on the surface of the charged photoconductive drum 1Y.

As shown in FIG. 1, an encoder EY is an optical rotary encoder configured to detect an encoder plate in which an origin indicator and an incremental pattern are formed by a pair of photo-interrupters. The encoder EY specifies a phase position of the photoconductive drum 1Y by outputting a Z-phase signal corresponding to the origin indicator and A- and B-phase signals corresponding to the incremental pattern.

In synchronism with the output of the encoder EY, a control portion 110 controls the exposure unit 3Y to set an expansion/contraction ratio of an image at each position in the rotation direction of the photoconductive drum 1Y and an image head position.

### <Definition of Image Height>

Here, a pixel number from a pixel at a center of a scanning line assigned to a specific pixel among a plurality of pixels arrayed on one scanning line on the photoconductive drum will be defined as an image height x. That is, the image height x is a coordinate distance in the main scanning direction from a center of scanning exposure shown in FIG. 3 to the specific pixel. The image height is zero at a center position in the rotation axis direction of the photoconductive drum 1Y. A direction heading downstream of the laser beam scanning direction from the center position in the rotation axis direction of the photoconductive drum 1Y will be referred to as a plus (+) direction of the image height and a direction heading upstream as a minus (−) direction of the image height.

### <Misregistration Detecting Sensor>

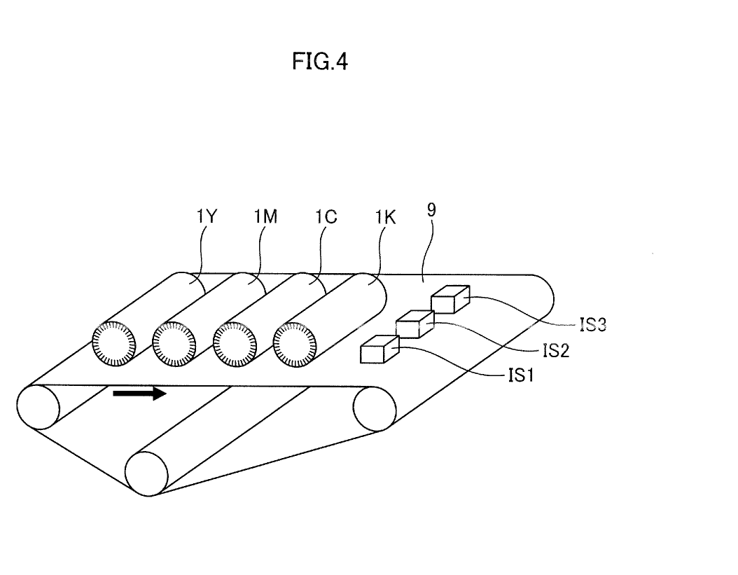

FIG. 4 is a diagram schematically illustrating disposition of misregistration detecting sensors. As shown in FIG. 4, the photoconductive drums 1Y, 1M, 1C, and 1K are juxtaposed along the intermediate transfer belt 9. Toner images formed on the photoconductive drums 1Y, 1M, 1C, and 1K are transferred respectively to the intermediate transfer belt 9 by means of the slip and transfer method. The misregistration detecting sensors IS1, IS2 and IS3 are disposed such that they face front, center (position where an image height is zero), and rear parts of the surface of the intermediate transfer belt viewing from the front-side of the drawing. The misregistration detecting sensors IS1, IS2 and IS3 are image sensors or line sensors with resolution of 10 μm in which light receiving elements are arrayed in a direction orthogonal to a rotation direction of the intermediate transfer belt 9. The misregistration detecting sensors IS1, IS2 and IS3 read positions in the main scanning direction of color shift inspecting patterns transferred to the intermediate transfer belt 9 through the processes of exposure, development and transfer described above.

<Control in Correcting Color Shift in Case where No Axial Fluctuation is Considered>

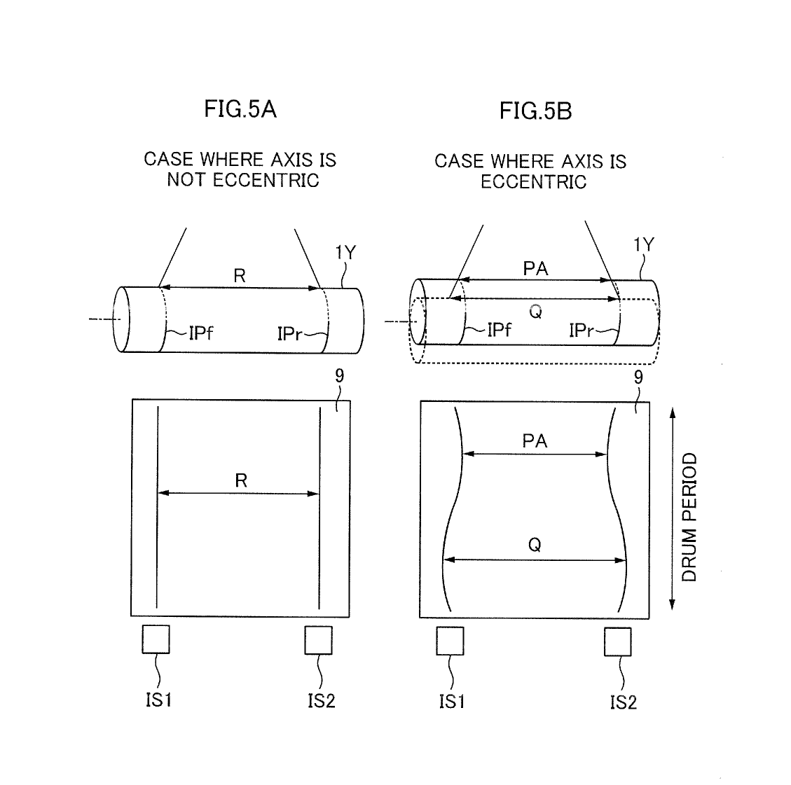

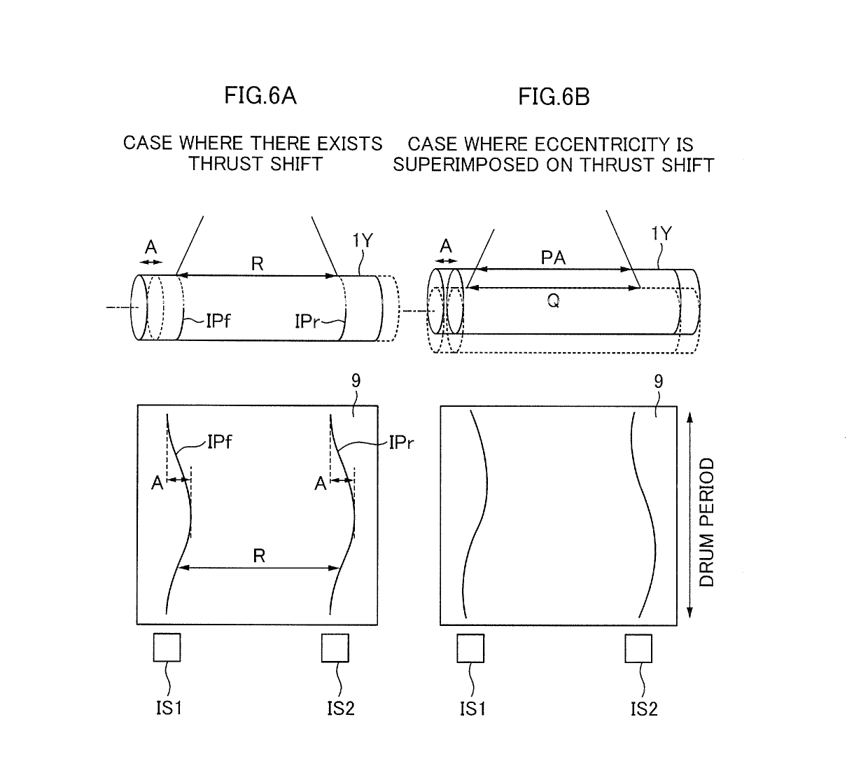

FIGS. 5A and 5B are diagrams schematically illustrating controls performed in correcting a color shift in a case where no axial fluctuation is considered, and FIGS. 6A and 6B are diagrams schematically illustrating the axial fluctuation. Because the image forming apparatus 100 forms a full-color image by superimposing toner images of the respective colors as shown in FIG. 4, a color shift occurs in an output image in the main scanning direction if the toner images of the respective colors are superimposed while being shifted in the main scanning direction. The color shift in the main scanning direction may be roughly divided into a cyclical component caused by cyclic positional fluctuations of the photoconductive drums 1Y, 1M, 1C, and 1K and a stationary component which is a constant level of positional fluctuations resulting from an averaged cyclic component.

A method for detecting the stationary component of the color shift in the main scanning direction has been established. That is, color shift inspecting patterns are formed on both end portions of the photoconductive drums 1Y, 1M, 1C, and 1K, are transferred to the intermediate transfer belt 9, and are detected by the misregistration detecting sensors IS1 and IS2. It is possible to eliminate the stationary color shift component in the main scanning direction and to improve image quality by matching average positions where the image heights of the exposed images in the photoconductive drums 1Y, 1M, 1C, and 1K are zeroed on a basis of results of the color shift inspecting patterns detected by the misregistration detecting sensors IS1 and IS2.

However, it is necessary to reduce the cyclic component of the color shift in addition to the stationary component in order to form a still higher quality image. The cyclic component of the color shift is generated by eccentricity and vibration of the photoconductive drums 1Y, 1M, 1C and 1K. It is difficult to accurately detect the cyclic component of the color shift because noise components need to be separated.

FIG. 5A schematically shows conditions in which a laser beam is incident on the photoconductive drum 1Y and color shift inspecting patterns IPf and IPr are transferred to the intermediate transfer belt 9. In a comparative example, the parallel and linear color shift inspecting patterns IPf and IPr are formed by a plurality of rotations, e.g., 10 rotations, of the photoconductive drum 1Y and are transferred to the intermediate transfer belt 9. Then, misregistration amounts are sampled repeatedly at predetermined timings by using the misregistration detecting sensors IS1 and IS2.

That is, a moving amount in the main scanning direction is measured to detect how far the positions in the main scanning direction of the color shift inspecting patterns IPf and IPr are shifted from specified positions in each of the sampled timings of the moving amount in the main scanning direction. Then, amplitudes and phases of positional fluctuations of the color shift inspecting patterns IPf and IPr in the rotation cycles of the photoconductive drum 1Y are detected. Fluctuation amounts of the color shift inspecting patterns IPf and IPr from reference positions are averaged per each phase position of the photoconductive drum 1Y to extract the cyclic component of the color shift in the main scanning direction and to cancel the cyclic component other than the rotation cycle of the photoconductive drum 1Y. Thus, correction information on a head position of the scanning line at each phase position of one rotation of the photoconductive drum 1Y and of the expansion/contraction ratio of the scanning line is acquired. The correction information is used to predictively control the exposure unit (3Y) in forming an image.

In a case where there is no cyclic component of a color shift, the linear color shift inspecting patterns IPf and IPr drawn on the both end portions of the photoconductive drum 1Y while being separated by R are transferred to the intermediate transfer belt 9 as shown in FIG. 5A.

If an axis of rotation of the photoconductive drum 1Y does not pass through a center the drum, a circumferential surface of the photoconductive drum 1Y generates an eccentric rotation and a swing rotation such as a spiral motion. If the photoconductive drum 1Y causes the swing rotation, a distance from the center of the scanning exposure to the surface of the photoconductive drum 1Y fluctuates, so that a cyclic fluctuation occurs in an image drawn on the photoconductive drum 1Y and a distorted toner image is transferred to the intermediate transfer belt 9 as shown in FIG. 5B.

If the axis of the photoconductive drum 1Y is eccentric from the center, the laser beam is incident on the photoconductive drum 1Y with an angle and a superficial position of the photoconductive drum 1Y fluctuates up and down, so that a cyclic fluctuation of a color shift occurs. Accordingly, as shown in FIG. 5B, a length PA, i.e., a distance, between the patterns IPf and IPr transferred to the intermediate transfer belt 9 in a case where the surface of the photoconductive drum 1Y comes up, i.e., becomes closer to the center of scanning exposure, is shorter than R and a length Q in a case where the surface of the photoconductive drum 1Y comes down, i.e., becomes farther from the center of scanning exposure, is longer than R. As a result, the color shift inspecting patterns IPf and IPr are transferred to the intermediate transfer belt 9 as distorted curves.

The cyclic fluctuation of the color shift inspecting patterns IPf and IPr can be eliminated as follows. That is, a correction table is prepared before forming an image, and the correction table is applied in forming an image in synchronism with the rotation of the photoconductive drum 1Y to control the exposure unit (3Y). Specifically, a head position of the image is shifted to shift the position of the color shift inspecting pattern IPf in the main scanning direction in synchronism with the rotation of the photoconductive drum 1Y such that the cyclic fluctuation amount of the color shift inspecting patterns IPf and IPr is canceled. In the same time, an image magnification (magnification of expansion/contraction of a length of the scanning line) is adjusted such that a cyclic moving amount of the color shift inspecting pattern IPf is canceled. The length of the scanning line is expanded/contracted in synchronism with the rotation of the photoconductive drum 1Y by multiplying an inverse number of the cyclic fluctuation amount of the distance in the main scanning direction of the color shift inspecting patterns IPf and IPr.

However, in a case where the photoconductive drum 1Y cyclically fluctuates its position in the rotation axis direction, i.e., accompanies a so-called axial fluctuation, it is unable to remove the influence of the cyclic fluctuation of the color shift in the main scanning direction only by the color shift inspecting patterns IPf and IPr.

In a case where the photoconductive drum 1Y causes the axial fluctuation of an amplitude A as shown in FIG. 6A and if the linear color shift inspecting patterns IPf and IPr distant by R are drawn on the both end portions of the photoconductive drum 1Y, they are transferred to the intermediate transfer belt 9 by having the amplitude A. In this case, it is possible to transfer the color shift inspecting patterns IPf and IPr in parallel and straightly to the intermediate transfer belt 9 by shifting the position of the color shift inspecting pattern IPr in the main scanning direction such that the cyclic moving amount of the color shift inspecting pattern IPf measured in advance is canceled.

In a case where the swing rotation and the axial fluctuation occur simultaneously in the photoconductive drum 1Y as shown in FIG. 6B, the cyclic fluctuation in the main scanning direction caused by the axial fluctuation is superimposed on the cyclic fluctuation in the main scanning direction caused by the swing rotation. In this case, it is unable to transfer the color shift inspecting patterns IPf and IPr in parallel and straightly to the intermediate transfer belt 9 just by expanding/contracting the length of the scanning line by the inverse number of the cyclic fluctuation amount of the distance in the main scanning direction of the color shift inspecting patterns IPf and IPr. Because frequency of the cyclic fluctuation of the swing rotation is equal to frequency of the axial fluctuation when the photoconductive drum 1Y cyclically fluctuates in the axial direction, it is unable to separate and extract the cyclic fluctuation amount caused by the swing rotation. Therefore, an error occurs considerably in the expansion/contraction of the scanning line, and the distortion of the image cannot be accurately corrected.

Then, according to the present embodiment, a color shift inspecting pattern (IPc) is formed at the center in the rotation axis direction of the photoconductive drum 1Y and is detected by a misregistration detecting sensor (IS2). Then, a moving amount of the axial fluctuation is directly measured by using the color shift inspecting pattern (IPc) and is subtracted from the fluctuation amounts in the main scanning direction of the color shift inspecting patterns IPf and IPr. This makes it possible to accurately find the fluctuation amount in the main scanning direction (expansion/contraction correction amount of the scanning line in particular) caused by the swing rotation by removing the influence of the axial fluctuation.

<Control in Correcting Color Shift in Case where Axial Fluctuation is Considered>

As shown in FIG. 1, the control portion 110 can execute a measuring mode by controlling the exposure unit 3Y and the developing unit 4Y. In the measuring mode, the misregistration inspecting toner images are formed at the both end portions and the center portion of the photoconductive drum 1Y and are transferred to the intermediate transfer belt 9. Then, misregistration amounts are detected by the misregistration detecting sensors IS1, IS2 and IS3 to obtain position information in the main scanning direction per each phase position where the scanning exposure is performed on the photoconductive drum 1Y.

Each of the misregistration inspecting toner images is a linear toner image continuous in the sub-scanning direction and developed from the electrostatic image formed by the exposure unit 3Y irradiating the laser beam at a predetermined coordinate position in the main-scanning direction for a plurality of times of rotation of the image carrier 1Y. More specifically, each misregistration inspecting toner image is a linear toner image continuous in the sub-scanning direction formed on the photoconductive drum 1Y in response to the exposure unit 3Y forming the liner image on a predetermined position on the main scanning line formed on a virtual exposure surface which is set as a position to be exposed to the exposure unit 3Y. It is noted that the exposure surface is set in parallel with an axis of rotation of the photoconductive drum 1Y by shifting by a radius of the photoconductive drum 1Y from the axis of rotation of the photoconductive drum 1Y initially. The misregistration inspecting toner image to be detected by the misregistration detecting sensor IS2 is formed with a scanning angle by which an incident angle of the laser beam to the main scanning line of the exposure surface (on the photoconductive drum 1Y) of the exposure unit 3Y is 90 degrees. When the incident angle of the laser beam is 90 degrees, the eccentric rotation of the photoconductive drum exerts no influence because no misregistration occurs in the main scanning direction even if the photoconductive drum 1Y fluctuates up and down. The misregistration inspecting toner images detected by the misregistration detecting sensors IS1 and IS3 are formed at positions where an image width becomes maximum on the exposure surface of the exposure unit 3Y. It is noted that the same applies also to the other photoconductive drums (the second image carriers) 1M, 1C, and 1K disposed along the rotation direction of the intermediate transfer belt 9 together with the photoconductive drum 1Y.

The control portion 110 corrects detection results of the misregistration detecting sensors IS1 and IS3 such that the axial moving amount fluctuating within the rotation cycle of the photoconductive drum 1Y is removed on a basis of the detection result of the misregistration detecting sensor IS2. The control portion 110 prepares exposure control information corresponding to the phase position in the sub-scanning direction of the photoconductive drum 1Y. The exposure control information is a table of data that specifies at least one of an expansion/contraction ratio in the main scanning direction of an image and a position in the main scanning direction of the image per each phase position where the scanning exposure is performed on the photoconductive drum 1Y.

The control portion 110 subtracts the detection result of the misregistration detecting sensor IS2 respectively from the detection results of the misregistration detecting sensors IS1 and IS3 per each phase position in the sub-scanning direction of the photoconductive drum 1Y in order to remove the axial moving amount fluctuating at equal cycle with the rotation cycle of the photoconductive drum 1Y.

### <Principle of Detection>

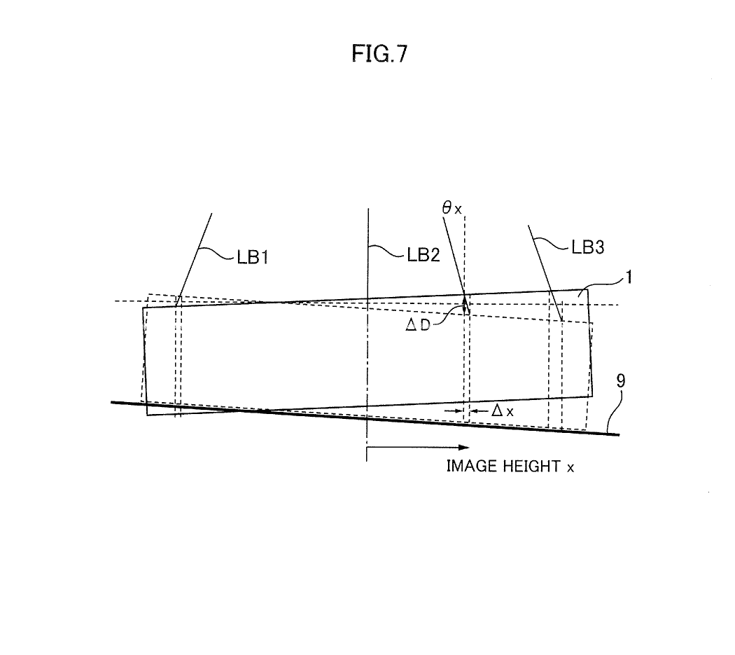

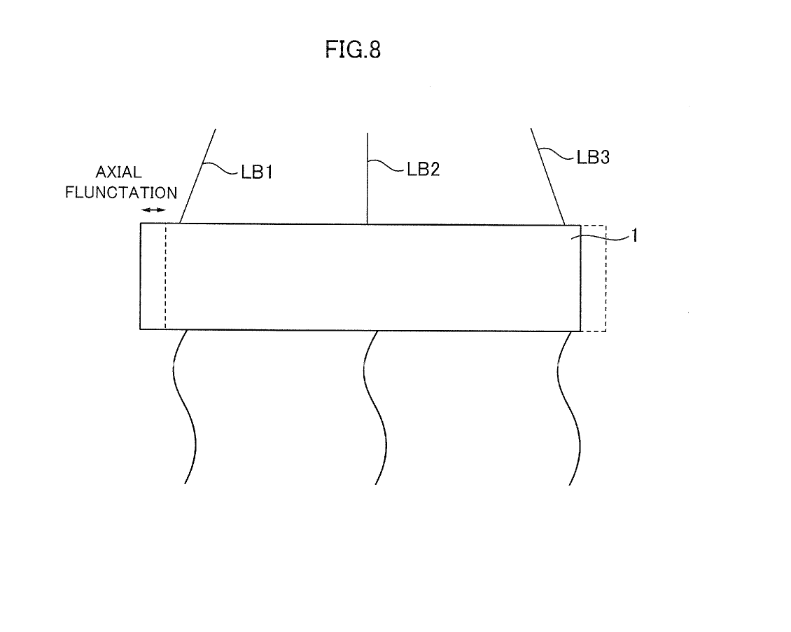

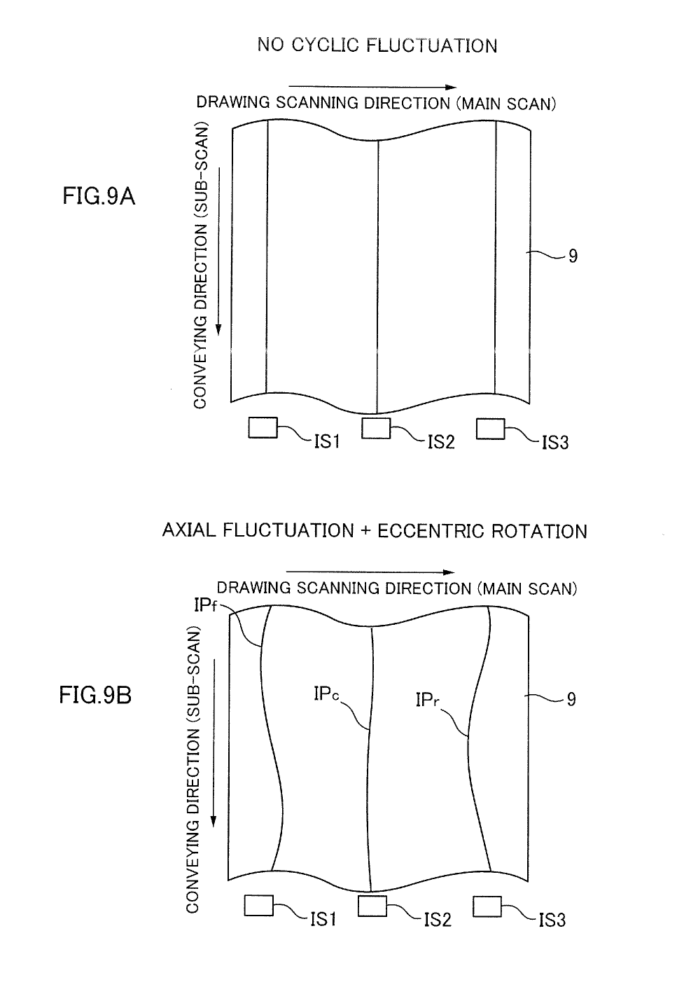

FIG. 7 is a diagram illustrating a method for detecting the cyclic moving amount caused by the swing rotation of the first embodiment, FIG. 8 is a diagram illustrating an influence of the axial fluctuation at each position in the main scanning direction, and FIGS. 9A and 9B are diagrams illustrating the color shift inspecting patterns transferred to an intermediate transfer belt.

As described above and as shown in FIG. 7, a pixel number from a pixel at a center of the scanning line of a specific pixel of a scanning line image is defined as an image height x. The laser beam is scanned to the circumferential surface of the photoconductive drum 1Y between LB1 and LB3 shown in FIG. 7. It is assumed such that an incident angle θx of the laser beam changes corresponding to the image height x, an amount of swing of the photoconductive drum 1Y is ΔD at the image height x, and the incident angle is θx. When the amount of swing of the photoconductive drum 1Y ΔD=0, the incident angle of the laser beam LB2 is 0° and a tangent is zero. A fluctuation of drawing position Δx of the laser beam at the image height x is determined by the amount of swing ΔD of the photoconductive drum 1Y and the incident angle θx of the laser beam, as follows:

Δx=ΔD×tan(θx) Eq. 1

Meanwhile, the axial fluctuation of the photoconductive drum 1Y appears equally at any image height x as shown in FIG. 8. As shown in FIG. 7, the fluctuation of drawing position Δx of the laser beam caused by the swing rotation of the photoconductive drum 1Y is zero at the position of the image height x=0. Therefore, the fluctuation amount caused by the swing rotation of the photoconductive drum 1Y is not contained in read data of the color shift inspecting pattern IPc when the image height x=0, and only the fluctuation amount caused by the axial fluctuation of the photoconductive drum 1Y is contained in the data.

As shown in FIG. 9A, the misregistration detecting sensors IS1, IS2 and IS3 are disposed such that they face the intermediate transfer belt 9. Corresponding to the misregistration detecting sensors IS1, IS2 and IS3, color shift inspecting patterns IPf, IPc, and IPr are formed on the photoconductive drum 1Y at front, center and rear parts thereof. The misregistration detecting sensors IS1 and IS3 face the color shift inspecting patterns IPf and IPr formed at the image heights of the both end portions of a maximum size of a recording medium on which an image can be formed. The misregistration detecting sensor IS2 faces the color shift inspecting pattern IPc formed at the place where the image height is 0. In a case where the photoconductive drum 1Y causes no swing rotation and axial fluctuation, the color shift inspecting patterns IPf, IPc, and IPr are transferred to the intermediate transfer belt 9 straightly without distortion.

As shown in FIG. 9B, the cyclic moving amount caused by the axial fluctuation is superimposed on the cyclic moving amount caused by the swing rotation of the photoconductive drum 1Y in the data of the color shift inspecting patterns IPf and IPr read by the misregistration detecting sensors IS1 and IS3. Therefore, it is possible to extract the cyclic moving amount caused by the swing rotation by removing the influence of the axial fluctuation of the photoconductive drum 1Y by subtracting the read data of the color shift inspecting pattern IPc respectively from the read data of the color shift inspecting patterns IPf and IPr.

### <Control System>

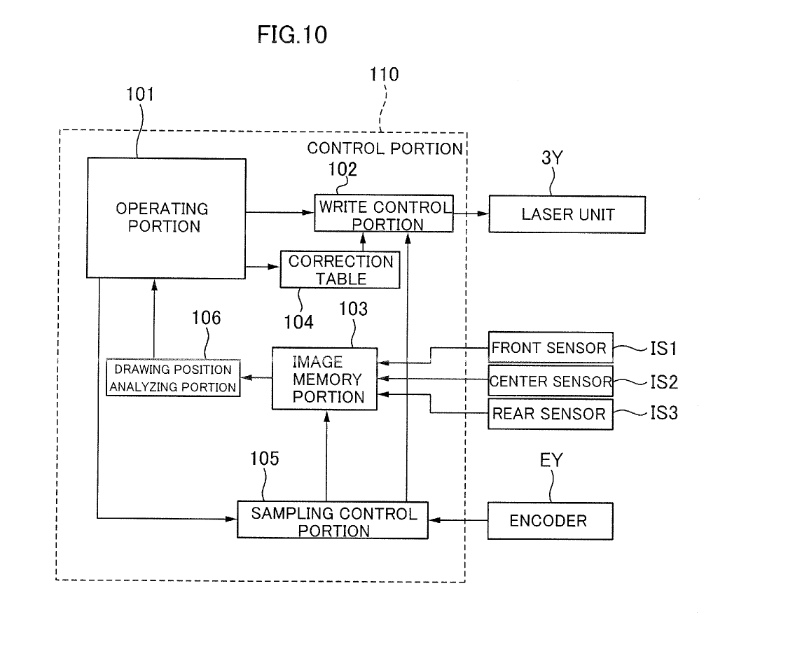

FIG. 10 is a block diagram of a control system in the image forming apparatus of the first embodiment. As shown in FIG. 10, a write control portion 102 controls a writing position of the laser beam. An image storage portion 103 stores image data read by the misregistration detecting sensors IS1, IS2 and IS3. As shown in FIG. 10, a correction table 104 feeds forward a correction value of a drawing position shown in Table 1 below to the write control portion 102. A method for finding each numerical value in Table 1 will be described in detail below.

TABLE 1

| | WRITE | | | | | | |
|---|---|---|---|---|---|---|---|
| ANGLE | BEGINNING | −L | −2/3 L | −1/3 L | 1/3 L | 2/3 L | L |
| 0 | 5 | 0 | 0 | 0 | 0 | 0 | 0 |
| 10 | 6 | 3 | 2 | 1 | 1 | 2 | 3 |
| 20 | 7 | 5 | 3 | 2 | 2 | 4 | 6 |
| 340 | 6 | −3 | −2 | −1 | −1 | −2 | −3 |
| 350 | 5 | −1 | −1 | 0 | 0 | 0 | −1 |

As shown in Table 1, the write control portion 102 corrects the write beginning position by changing a write beginning timing of drawing of the laser beam in the exposure unit (laser unit) 3Y by making reference to the value of the correction table 104 in normally forming an image. The write control portion 102 also corrects a partial magnification of the scanning line in the exposure unit 3Y by making reference to the value of the correction table 104 in normally forming an image. Specifically, the write control portion 102 sets the partial magnification of an image along a main scanning line by inserting/deleting a piece of pixels per each region of six scanning angle range −L to +L along the scanning line as shown in Table 1. That is, the write control portion 102 corrects the distortion of the image caused by the swing rotation of the photoconductive drum 1Y by appropriately inserting/deleting the piece of pixels corresponding to a length of the scanning line to be increased/decreased.

The control of the write control portion 102 sending the correction value to the exposure unit 3Y is performed in accordance to a signal of a sampling control portion 105. The sampling control portion 105 generates detecting timing of the misregistration detecting sensors IS1, IS2 and IS3 and timing for writing the correction value. The sampling control portion 105 sends the timing signal to the image storage portion 103 and the write control portion 102 by receiving output signals (Z-phase, A-phase, and B-phase) of the encoder.

During when no image is formed, the control portion 110 actuates the exposure unit 3Y to form the color shift inspecting patterns IPf, IPc, and IPr on the photoconductive drum 1Y and measures the cyclic fluctuation amount in the main scanning direction of the photoconductive drum 1Y. Then the control portion 110 updates the correction value of the correction table 104 on a basis of the measured result. Receiving a sampling signal from the sampling control portion 105, the image storage portion 103 samples and stores outputs of the misregistration detecting sensors IS1, IS2 and IS3.

### <Output of Encoder>

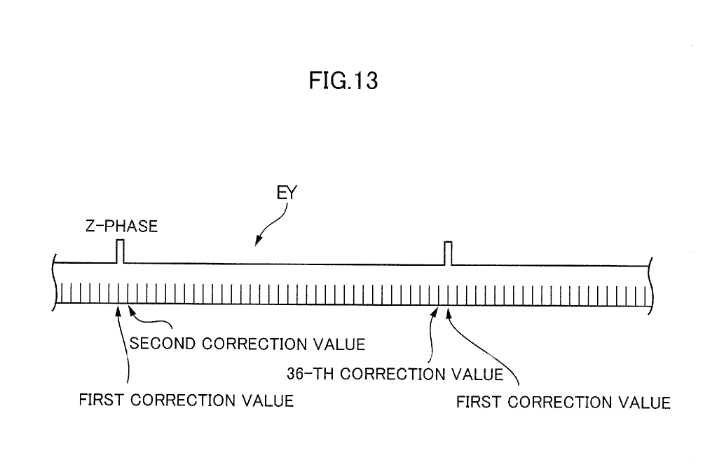

FIG. 13 is a diagram illustrating the output of the encoder. As shown in FIG. 1, the photoconductive drum 1Y is provided with the encoder EY, and the control portion 110 can discriminate the phase position of the photoconductive drum 1Y on a basis of the output of the encoder EY.

A Z-phase of the encoder EY shown in FIG. 13 is a reference signal of the phase of the photoconductive drum 1Y. Each correction value of the correction table 104 is prepared in synchronism with the Z-phase. As shown in Table 1, the correction table 104 is prepared by dividing one round of the photoconductive drum 1Y into 36 parts and by allocating correction values to the respective parts. Rewriting and reading of the correction table 104 are changed over at equal clock intervals.

Recognizing the Z-phase, the write control portion 102 selects a first correction value. Then, a correction value stored in an address of 0 degree in Table 1 is read. As the rotation of the photoconductive drum 1Y advances, the correction values to be outputted of the correction table 104 are switched sequentially to a 36-th correction value, and as the photoconductive drum 1Y turns by one round and the write control portion 102 recognizes the Z-phase, the correction value returns to the first correction value again. It is possible to correct fluctuation of a laser beam drawing position by performing the similar operation also on the photoconductive drums 1M, 1C, and 1K of the other colors.

### <Procedure for Preparing Correction Table>

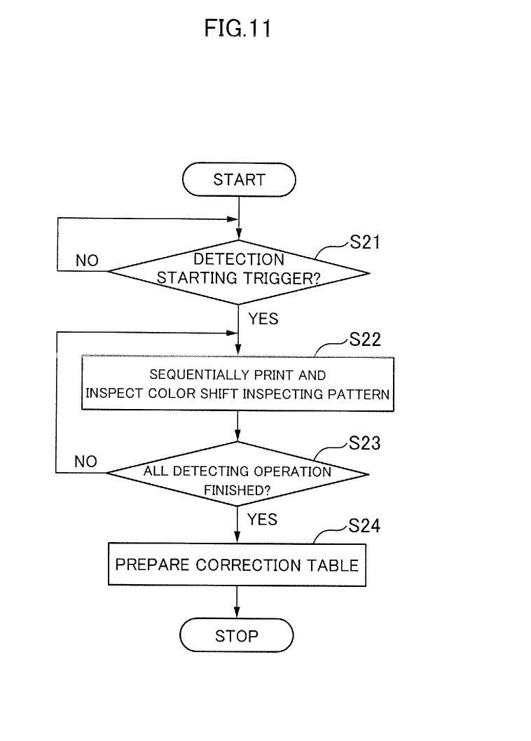

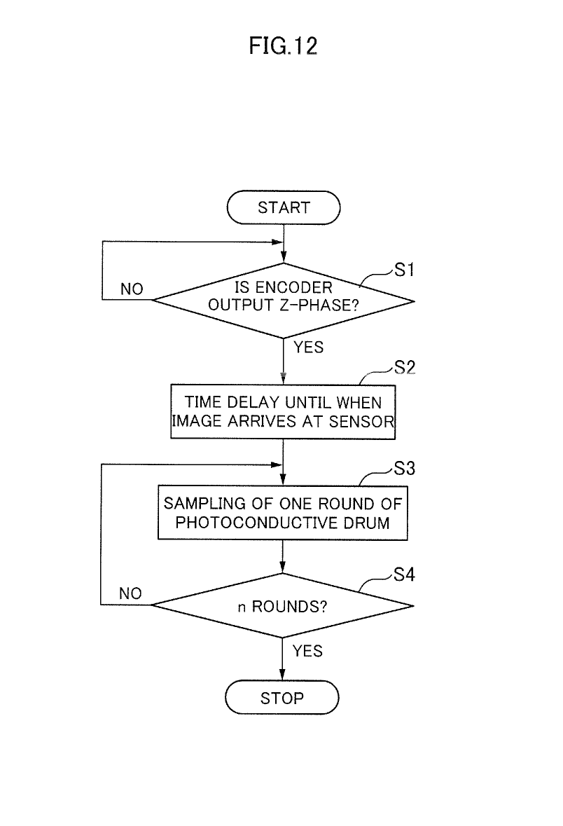

FIG. 11 is a flowchart of a control performed in updating the correction table in the first embodiment, and FIG. 12 is a flowchart of a control performed in detecting the color shift inspecting pattern of each color. A process in detecting the color shift inspecting pattern of each color is executed in the same manner, and a process in detecting the color shift inspecting pattern is also executed in the same manner for the front, center and rear color shift inspecting patterns. Therefore, the following explanation will be made on the process for detecting the yellow and front color shift inspecting pattern, and an overlapped explanation on the processes for detecting the other colors and center and rear color shift inspecting patterns will be omitted here.

As shown in FIG. 11 (with reference to FIG. 10), when a trigger of starting a sequence of preparing the correction table 104 is inputted, i.e., Yes in Step 21, the control portion 110 forms the color shift inspecting patterns IPf, IPc, and IPr and detects them by the misregistration detecting sensors IS1, IS2 and IS3 to measure a cyclic fluctuation amount in the main scanning direction of the photoconductive drum 1Y in Step 22. It is noted that because an elapsed change of the cyclic fluctuation in the main scanning direction of the photoconductive drum 1Y is small, the trigger is inputted in Step 21 either in installing the image forming apparatus 100, every time when a certain number of prints is outputted, or when a user makes a control through a control panel.

When the measurement of the cyclic fluctuation in the main scanning direction of the photoconductive drum 1Y is finished, i.e., No in Step 23, the control portion 110 starts to measure a cyclic fluctuation in the main scanning direction of the photoconductive drum 1M in Step 22. When the measurement of the cyclic fluctuation in the main scanning direction of all the drums up to the photoconductive drum 1K is thus finished, i.e., Yes in Step 23, the control portion 110 processes the measured data and updates the correction table 104 in Step 24.

As shown in FIG. 12 (with reference to FIG. 10), when the image forming portion PY starts to form the color shift inspecting pattern, the control portion 110 issues a command to the sampling control portion 105 and waits until when the encoder EY of the photoconductive drum 1Y detects the Z-phase (reference pulse of one round) in Step 1.

When the Z-phase is found, i.e., Yes in Step 1, the control portion 110 waits for a delay time until when the color shift inspecting pattern arrives at the misregistration detecting sensor IS1 in Step 2. The delay time is a sum of a time until when a toner image arrives at the primary transfer portion from a start of exposure to the photoconductive drum 1Y and a moving time of the intermediate transfer belt 9 from the primary transfer portion to the misregistration detecting sensor IS1. In a case where a process speed is 300 mm/sec., and a diameter of the photoconductive drum 1Y is 80 mm, the time until when the toner image arrives at the primary transfer portion from the start of exposure to the photoconductive drum 1Y is 0.42 seconds by supposing that it takes about a half circumference of the photoconductive drum 1Y. A distance from the primary transfer portion to the misregistration detecting sensor IS1 is 1000 mm in total when a distance between the photoconductive drums is assumed to be 250 mm and a distance between the misregistration detecting sensor IS1 and the photoconductive drum 1K of black is also 250 mm. When the process speed is 300 mm/sec., a time which takes from the primary transfer portion to the misregistration detecting sensor IS1 is 1000 mm 300 mm/sec=about 3.33 seconds. Accordingly, the delay time is 3.75 seconds in total.

When the delay time elapses in Step 2, the color shift inspecting pattern arrives at the misregistration detecting sensor IS1, so that sampling timing signals of one round of the photoconductive drum 1Y are generated in Step 3.

Rotational frequency of the photoconductive drum 1Y is about 1.2 Hz under the condition described above. It is necessary to sample several-tens misregistration data in one round of the photoconductive drum 1Y in order to detect a multiplied wave component of several times of the rotational frequency of the photoconductive drum 1Y. Here, 36 misregistration data at intervals of 10 degrees are sampled in one rotation of the photoconductive drum 1Y in Step 3.

It is necessary to sample misregistration data of a plurality of rotations of the photoconductive drum 1Y in order to add and average the sampled data and to remove noise components unrelated to the rotation cycle of the photoconductive drum 1Y. Here, a number of the addition is set as n=10, and ten rotations of the misregistration data are sampled. If the sampling signals of one round are generated in Step 3, it is checked whether or not the photoconductive drum 1Y has turned by n=10 in Step 4. If the number has not reached the ten rounds, the sampling is continued in Step 3 and if the number has reached the ten rounds, i.e., Yes in Step 4, the sampling of the misregistration data is stopped.

### <Data Processing>

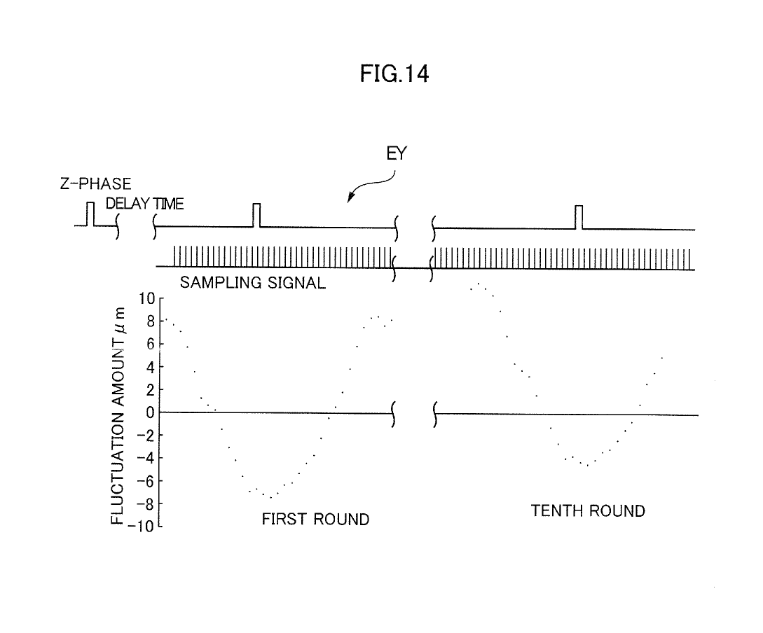

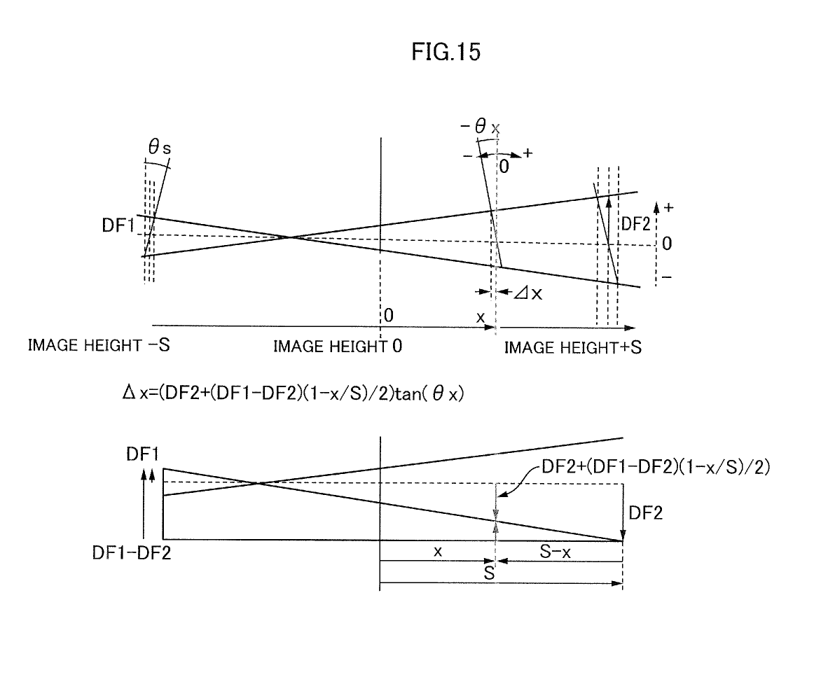

FIG. 14 is a graph illustrating image data of the cyclic positional fluctuation in the main scanning direction, and FIG. 15 illustrates a relationship between an eccentric rotational amount and an incident angle of the laser beam.

As shown in FIG. 14, outputs of the front misregistration detecting sensor IS1 are sampled in synchronism with outputs of the encoder EY provided in the photoconductive drum 1Y. That is, after when the delay time described above has elapsed since when the Z-phase of the encoder EY was recognized, 36 values each of the misregistration detecting sensor IS1 from a first round to a tenth of the photoconductive drum 1Y, i.e., 360 values in total, are sampled and stored in the image storage portion 103. The 360 sampling data are numerical values converted from the signals of the misregistration detecting sensor IS1 into positions and contains stationary fluctuation components other than cyclic fluctuation components. Therefore, it is necessary to remove the stationary fluctuation components from the image data stored in the image storage portion 103 before calculating the cyclic fluctuation components.

A drawing position analyzing portion 106 extracts fluctuation caused by the photoconductive drum 1Y from the image data stored in the image storage portion 103. Because sampling of the image data is carried out after an adequate delay time from the detection of the Z-phase, the image data stored in the image storage portion 103 is synchronized with the Z-phase.

The drawing position analyzing portion 106 removes the stationary fluctuation components by averaging all sampled data and by subtracting an average value from each data.

IS1 (front): IDF 1, IDF 2, . . . IDF n, IDF 360

IS2 (center): IDC 1, IDC 2, . . . IDC n, IDC 360

IS3 (rear): IDR 1, IDR 2, . . . IDR n, IDR 360

After removing the stationary fluctuation components, the drawing position analyzing portion 106 removes disturbance components other than the multiplied component synchronized with the photoconductive drum 1Y by averaging per every rotation cycle of the photoconductive drum 1Y. That is, the drawing position analyzing portion 106 executes operations of adding every 36 data, i.e., one cycle of the photoconductive drum 1Y, and dividing by 10 for the front, center and rear data, respectively, as the following equations, where m is an ordinal number from 1 to 36 obtained by dividing one round of the photoconductive drum 1Y into 36 parts:

$$IDFAm = \frac{1}{10} {\sum }_{k = 0}^{9} IDF ( m + {k}^{*} 36 ) \\ IDCAm = \frac{1}{10} {\sum }_{k = 0}^{9} IDC ( m + {k}^{*} 36 ) \\ IDRAm = \frac{1}{10} {\sum }_{k = 0}^{9} IDR ( m + {k}^{*} 36 ) \qquad Eq . 2$$

IDFAm, IDCAm, and IDRAm calculated as described above represent the cyclic fluctuation amount of the front, center and rear drawing positions, respectively.

As shown in FIG. 9B, the center cyclic fluctuation amount IDCAm is the axial fluctuation amount of the photoconductive drum 1Y. Therefore, it is possible to obtain the front drawing position fluctuation amount caused by the swing rotation of the photoconductive drum 1Y by subtracting the center cyclic fluctuation amount IDCAm from the front cyclic fluctuation amount IDFAm, i.e., IDFAm−IDCAm. In the same manner, it is possible to obtain the rear drawing position fluctuation amount caused by the swing rotation of the photoconductive drum 1Y by subtracting the center cyclic fluctuation amount IDCAm from the rear cyclic fluctuation amount IDCAm, i.e., IDCAm−IDCAm.

As shown in FIG. 15, the misregistration detecting sensor IS2 is installed at the position where the image height is zero, the misregistration detecting sensor IS1 is installed at the position where the image height is −S, and the misregistration detecting sensor IS3 is installed at the position where the image height is +S. The side of the misregistration detecting sensor IS1 is a side where the scanning exposure of the laser beam is started. An incident angle of the laser beam at the image height −S where the misregistration detecting sensor IS1 is installed is set as Os. The sign of the incident angle θs of the laser beam is defined as shown in FIG. 15 to match with a sign of the eccentric rotational amount. At this time, the yellow front eccentric rotational amount DFYFm is a value obtained by dividing the drawing position fluctuation amount by tan θs. The yellow rear eccentric rotational amount DFYFm can be also obtained in the same manner.

DFYFm=(IDFAm−IDCAm)/tan(θs)

DFYRm=(IDRAm−IDCAm)/tan(θs) Eq. 3

Thus, the front and rear eccentric rotational amounts are obtained for the respective photoconductive drums. ‘m’ below is a number from 1 to 36 obtained by dividing one round of the drum into 36 parts as described above, and the cyclic fluctuation components caused by the eccentric rotation of one round of the drum can be obtained by sequentially calculating from 1 to 36:

Eccentric rotational amount of the photoconductive drum 1Y: DFYFm and DFYRm

Eccentric rotational amount of the photoconductive drum 1M: DFMFm and DFMRm

Eccentric rotational amount of the photoconductive drum 1C: DFCFm and DFCFm

Eccentric rotational amount of the photoconductive drum 1K: DFKFm and DFKRm

The eccentric rotational amount of one round of the photoconductive drum thus obtained is transmitted to the operating portion 101. The operating portion 101 calculates a drawing position fluctuation amount Δx at each image height x on a basis of the transmitted eccentric rotational amount as shown in FIG. 15.

The eccentric rotational amounts at the image heights −S and +S are defined here as DF1 and DF2. Because the eccentric rotational amount is a cyclic fluctuation and the stationary component has been removed previously, the drum oscillates up and down with an average position of the oscillation of zero. An incident angle of the laser beam at a position where an image height is x is defined as θx with a sign as shown in FIG. 15.

The operating portion 101 calculates the drawing position fluctuation amount Δx caused by the eccentric rotation at the image height x by the following equation:

Δx=(D2+(D1−D2)(1−x/S)/2)tan(θx) Eq. 4

That is, the operating portion 101 calculates the drawing position fluctuation amount Δx caused by the eccentric rotation at the image height x by substituting the front eccentric rotational amount DFYFm for D1 in the equation, substituting the rear eccentric rotational amount DFYRm for D2, and substituting the image height X and the laser beam incident angle θx.

The operating portion 101 calculates the drawing position fluctuation amount caused by the eccentric rotation at the image write beginning position by substituting the eccentric rotational amount described above and the image height at the image write beginning position of the laser beam in the equation obtaining the drawing position fluctuation amount Δx described above. Because the center cyclic fluctuation amount IDCAm is a thrust shift amount of the photoconductive drum 1Y, cyclic fluctuation amounts IDFAm and IDRAm at the image write beginning position can be obtained by adding the center cyclic fluctuation amount with the drawing position fluctuation amount Δx caused by the eccentric rotation just obtained now. The sign of the cyclic fluctuation amount is reversed to prepare correction data of the write beginning position of the correction table 104.

Next, data for adjusting the partial magnification on the scanning line in the correction table 104 is prepared.

In the present embodiment, one line of the scanning line is divided into six parts and the magnification is corrected in each part. When a width of printing is an image height −L to +L, each divided length is L/3. The drawing position fluctuation amount caused by the eccentric rotation is obtained by Equation 4. The operating portion 101 prepares a table of 0, 10, . . . M, . . . 340 and 350 degrees per 10 degrees each from a home position of the drum rotation phase by using Equation 4. A reference is made on the eccentric rotational amounts DFYFm and DFYFm described above for D1 and D2 in Equation 4 if the drum is the photoconductive drum 1Y. Table 2 (identical with Table 1) is one exemplary correction table of the write beginning positions in the photoconductive drum 1Y calculated as described above and the expansion/contraction amount of the scanning line in each image height. Correction amounts of expansion/contraction of the scanning line in each region are stored in correspondence to each image height of L/3, 2L/3 and L. Values to be corrected are stored in unit of μm in the correction table.

TABLE 2

| | WRITE | | | | | | |
|---|---|---|---|---|---|---|---|
| ANGLE | BEGINNING | −L | −2/3 L | −1/3 L | 1/3 L | 2/3 L | L |
| 0 | 5 | 0 | 0 | 0 | 0 | 0 | 0 |
| 10 | 6 | 3 | 2 | 1 | 1 | 2 | 3 |
| 20 | 7 | 5 | 3 | 2 | 2 | 4 | 6 |
| 340 | 6 | −3 | −2 | −1 | −1 | −2 | −3 |
| 350 | 5 | −1 | −1 | 0 | 0 | 0 | −1 |

According to the image forming apparatus of the first embodiment, even if the photoconductive drum causes the axial fluctuation, it is possible accurately correct the axial fluctuation of the photoconductive drum and the cyclic fluctuation of the color shift caused by the eccentric rotation by separating the cyclic fluctuation component of the drawing position caused by the eccentric rotation per each photoconductive drum. Even if the photoconductive drum 1Y causes the axial fluctuation, it is also possible to accurately correct the color shift at each phase position of the photoconductive drum corresponding to the eccentric rotation by separating the relative color shift of the drawing position caused by the eccentric rotation in high precision. Because the image forming apparatus of the first embodiment also obtains the axial fluctuation of the photoconductive drum directly from the detection result of the color shift inspecting pattern formed at the image height zero, it is possible to accurately separate and extract the cyclic fluctuation of the drawing position caused by the eccentric rotation of the photoconductive drum. Because the image forming apparatus calculates the write beginning position at each phase position of the photoconductive drum and the expansion/contraction amount of the scanning line at each image height region on the basis of the extracted cyclic fluctuation, it is possible to correct the color shift accurately, significantly contributing to improvement of quality of the output image. Thus, the image forming apparatus of the first embodiment can significantly contribute to the reduction of color shift of each color.

### Second Embodiment

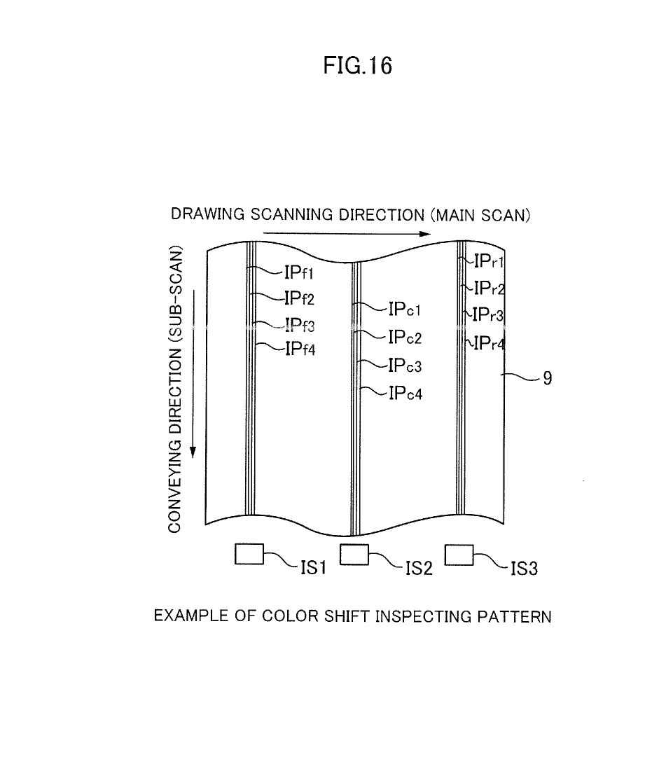

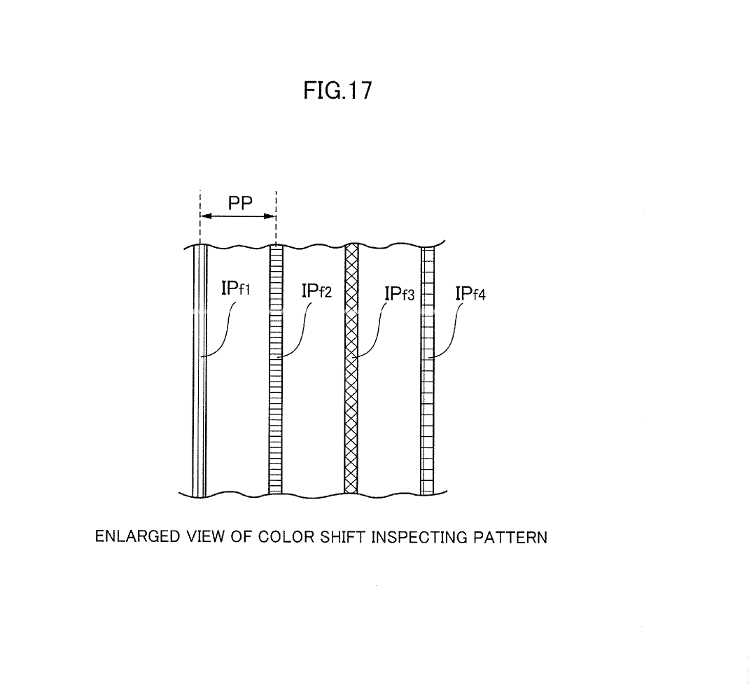

FIG. 16 is a diagram illustrating disposition of the color shift inspecting patterns in a second embodiment, and FIG. 17 is an enlarged view of the color shift inspecting pattern. The method of correcting the color shift by obtaining the drawing position fluctuation amount per each photoconductive drum has been explained in the first embodiment. Whereas, the second embodiment is arranged to obtain a color shift amount from other photoconductive drums on a basis of one photoconductive drum to correct a relative color shift. Because the configuration of forming the color shift inspecting pattern on the photoconductive drum, transferring it to the intermediate transfer belt, and of detecting it by the misregistration detecting sensor, the controls, the detection principle of the cyclic fluctuation amount, and the method for preparing the correction table of the second embodiment are the same with those of the first embodiment, the second embodiment will be explained by placing an emphasis on differences from the first embodiment.

As shown in FIG. 4, the plurality of photoconductive drums 1Y, 1M, 1C, and 1K is disposed along the rotation direction of the intermediate transfer belt 9 which is one exemplary belt member such that images are superimposed on the intermediate transfer belt 9. Misregistration inspecting toner images formed at both end portions and a rear center portion of the respectively photoconductive drums 1Y, 1M, 1C, and 1K are formed by shifting coordinate positions of main scanning per each photoconductive drums 1Y, 1M, 1C, and 1K and are transferred to the intermediate transfer belt 9 in parallel.

In the second embodiment, the color shift inspecting patterns are formed in parallel on the photoconductive drums 1Y, 1M, 1C, and 1K and are transferred to the intermediate transfer belt 9. Timings for forming the color shift inspecting patterns on the photoconductive drums 1Y, 1M, 1C, and 1K are adjusted such that the color shift inspecting patterns at the same phase position of the photoconductive drums 1Y, 1M, 1C, and 1K are arrayed on the intermediate transfer belt 9.

As shown in FIG. 16, color shift inspecting patterns IP_{f1} through IP_{f4}, IP_{c1} through IP_{c4}, and IPᵣ₁ through IPᵣ₄ of four colors are transferred in proximity with each other on the intermediate transfer belt 9 in order to detect a relative color shift of yellow, magenta, cyan, and black. Then, the misregistration detecting sensors IS1, IS2 and IS3 read the four colors of the color shift inspecting patterns, respectively, in the same time. As shown in FIG. 17, the color shift inspecting patterns IP_{f1} through IP_{f4} of yellow, magenta, cyan, and black are formed on the intermediate transfer belt 9 with intervals PP. It is noted that the same applies also to the color shift inspecting patterns IP_{c1} through IP_{c4} and IPᵣ₁ through IPᵣ₄.

If there exist no axial move and eccentric rotation in the photoconductive drums 1Y, 1M, 1C, and 1K, the four linear color shift inspecting patterns P1, P2, P3 and P4 are arrayed on the intermediate transfer belt 9 at equal intervals PP. However, if the axial move and eccentric rotation exist in the photoconductive drums 1Y, 1M, 1C, and 1K, the four color shift inspecting patterns P1, P2, P3 and P4 are curved and the mutual intervals fluctuate cyclically with the rotation cycle of the photoconductive drums.

Then, in the second embodiment, distances from other color shift inspecting patterns P2, P3 and P4 are measured on a basis of the yellow color shift inspecting pattern P1 at 36 phase positions per 10 degrees of one round of 360 degrees of the photoconductive drum by ten rotations of the photoconductive drum.

As shown in FIG. 10, when the preparation of the correction table 104 is commanded, the control portion 110 forms the color shift inspecting patterns P1, P2, P3 and P4 on the intermediate transfer belt 9 in parallel while adjusting the phase positions and detects them by the misregistration detecting sensors IS1, IS2 and IS3. Because processing of detection data of the misregistration detecting sensors IS1, IS2 and IS3 is the same, data processing of the misregistration detecting sensor IS1 will be explained below.

36 values each of the misregistration detecting sensor IS1 synchronized per 10 degrees each of one round of 360 degrees of the photoconductive drums 1Y, 1M, 1C, and 1K from first to tenth rounds thereof, i.e., 360 values in total, are sampled and are stored in the image storage portion 103. Because the 360 sampling data contain the cyclic fluctuation component (AC component) and the stationary fluctuation component (DC component), the stationary fluctuation component (DC component) is removed before calculating the cyclic fluctuation component. While the color shift inspecting patterns are read in accordance to the flow shown in FIG. 11 in the same manner with the first embodiment, the present embodiment is different in that the four colors are read simultaneously. The drawing position analyzing portion 106 takes an average value of all sampled data and removes the stationary fluctuation component by subtracting the average value from the respective data (n: 1 to 360):

color shift inspecting pattern P1: YD1, YD2, . . . YDn, . . . YD360

color shift inspecting pattern P2: MD1, MD2, . . . MDn, . . . MD360

color shift inspecting pattern P3: CD1, CD2, . . . CDn, . . . CD360

color shift inspecting pattern P4: KD1, KD2, . . . KDn, . . . KD360

Because a pitch of the patterns is PP as shown in FIG. 17, a color shift of each color pattern to the yellow pattern can be obtained from the following equations, where n(1 to 360) are sequence of data:

color shift IS1: IDFn=MDn−YDn−PP

color shift IS2: IDFn=CDn−YDn−PP×2

color shift IS3: IDFn=KDn−YDn−PP×3

Thereby, as regard the misregistration detecting sensor IS1, IDF1 through IDF360 are found by calculating all from first to 360^{th} data. As regard the misregistration detecting sensor IS2, IDC1 through IDC360 are found by calculating all from first to 360^{th} data. As regard the misregistration detecting sensor IS3, IDR1 through IDR360 are found by calculating all from first to 360^{th} data.

The process carried out after detecting the color shift of each color is totally the same with that of the first embodiment. In a case of a color shift of magenta for example, the averaging process at the respective 36 positions is carried out in the same manner with Equation 2 described above to extract a cyclic moving amount of the rotation cycle of the photoconductive drums 1Y and 1M. Within the equation, m is a number from 1 to 36 obtained by dividing one round of the photoconductive drums 1Y and 1M into 36 parts:

$$IDSFAm = \frac{1}{10} {\sum }_{k = 0}^{9} IDF ( m + {k}^{*} 36 ) \\ IDSCAm = \frac{1}{10} {\sum }_{k = 0}^{9} IDC ( m + {k}^{*} 36 ) \\ IDSRAm = \frac{1}{10} {\sum }_{k = 0}^{9} IDR ( m + {k}^{*} 36 ) \qquad Eq . 5$$

IDSFAm, IDSCAm and IDSRAm thus obtained represent, respectively, the relative color shift amounts caused by drawing misregistration of magenta and yellow of the front, center and rear patterns. Then, IDSCAm is a relative color shift amount caused by the axial fluctuation of the photoconductive drums of yellow and magenta. Therefore, it is possible to extract the relative color shift amount which is caused by the eccentric rotation and from which the influence of the axial fluctuation of the photoconductive drums of yellow and magenta is removed by subtracting IDSCAm from IDSFAm and IDSCAm, respectively, in the same manner with the first embodiment. That is, a process similar to Equation 3 described above is executed to obtain the front relative eccentric rotational amount DFMSFm and the rear relative eccentric rotational amount DFMSRm about each phase position of m=1 to 36. This is a cyclic moving amount in the main scanning direction caused by the eccentric rotation in yellow and magenta.

DFMSFm=(IDSFAm−IDSCAm)/tan(θs)

DFMSRm=(IDSRAm−IDSCAm)/tan(θs) Eq. 6

In the same manner, the front relative eccentric rotational amount DFCSFm and the rear relative eccentric rotational amount DFCSFm in cyan and yellow are obtained. Still further, the front relative eccentric rotational amount DFKSFm and the rear relative eccentric rotational amount DFCKRm in black and yellow are obtained.

These three types of relative eccentric rotational amounts are transmitted to the operating portion 101. Because the second embodiment is carried out on the basis of yellow, a correction value of yellow is zero. When the three types of relative eccentric rotational amounts are obtained, it is possible to calculate the relative fluctuation amount at each image height by using Equation 4 described above.

It is possible to calculate a color shift amount caused by the relative eccentric rotation at each image height by calculating Equation 4 by substituting DFMSFm and DFMSFm for DF1 and DF2, if the photoconductive drum is the magenta photoconductive drum 1M, and substituting the image height X and its incident angle θx. Similarly to the first embodiment, S is an image height of the sensor.

It is also possible to obtain the cyclic fluctuation component amount of the write beginning position from a value obtained by calculating the relative color shift amount caused by the eccentric rotation and IDSCAm by using Equation 4 similarly to the first embodiment.

The correction table also becomes correction data of the write beginning position of the correction table 104 by reversing the sign of the obtained value.

The correction table 104 that feeds forward the partial magnification is also prepared in the same manner with the first embodiment. The correction table 104 is prepared in the same manner also for cyan and black.

The correction value is zero in the reference yellow photoconductive drum 1Y in forming an image. The photoconductive drums 1M, 1C, and 1K of magenta, cyan, and black recognize the Z-phase of the encoder EY and correct the write beginning position by making reference to the correction table 104 corresponding to the 36 phase positions and the magnification of per each region in the same manner with the first embodiment.

The photoconductive drums 1Y, 1M, 1C, and 1K match phases of the photoconductive drums 1Y, 1M, 1C, and 1K by being driven at constant angular velocity based on outputs of the encoders EY, EM, EC and EK in forming an image. When the phase changes with time as a power source is turned ON and OFF for example, a phase relationship of the photoconductive drums 1Y, 1M, 1C, and 1K is returned to a condition when the correction table 104 is prepared on a basis of the outputs of the encoders EY, EM, EC and EK before forming an image. Because the correction table 104 corrects the relative color shift in the second embodiment, the phase relationship of the photoconductive drums 1Y, 1M, 1C, and 1K is kept same with the condition when the correction table 104 is prepared. The control of matching the phases of the plurality of photoconductive drums has been proposed variously since the past, a detailed explanation will be omitted here.

While the second embodiment has been described on the basis of the yellow color shift inspecting pattern, the other color shift inspecting pattern may be a standard.

The arrangement shown in the second embodiment of disposing the plurality of colors of color shift inspecting patterns on the intermediate transfer belt in parallel while adjusting their phases and of detecting them simultaneously by the misregistration detecting sensors IS1, IS2 and IS3 may be applied also in the first embodiment. It is possible to shorten a detection time as compared to the case of forming and measuring the color shift inspecting pattern by one color each.

In the case where the plurality of colors of color shift inspecting patterns is simultaneously detected, the misregistration detecting sensors IS1, IS2 and IS3 simultaneously read the plurality of colors of color shift inspecting patterns and the drawing misregistration is calculated by the calculation method described in the first embodiment per each color.

It is preferable to keep an installation height of the misregistration detecting sensor IS1 on the write beginning side of the scanning line of the photoconductive drum 1Y to be substantially on a same level with the drawing starting position of the laser beam. It is because IDFAm described above indicates the drawing position fluctuation amount caused by the eccentric rotation+axial fluctuation and it becomes a correction value of the write beginning position just by changing the sign and may be used in the correction table as it is.

### Third Embodiment

The present invention can be carried out also by another embodiment whose configuration, in part or in whole, is replaced with its alternative configuration as long as the configuration has a measuring mode of forming the color shift inspecting patterns at the center portion and the both end portions of the photoconductive drum.

Accordingly, the belt member is not limited to be the intermediate transfer belt. It is also possible to carry out the present invention by an image forming apparatus configured to transfer a toner image on a recording medium carried on a recording medium conveyance body. In this case, the belt member is the recording medium conveyance body. The belt member may be also a transfer belt.

The invention is not also limited to disposed the image carriers in the order of yellow, magenta, cyan, and black from the upstream. The invention is not also limited to the four color image forming apparatus. It is apparent that the invention is effective also in a monochrome printer from the point that the correction can be made per each image carrier. It is possible to adjust the color shift by the similar operation with the first or second embodiment even if many more colors are added by disposing image carriers in any order. The color shift inspecting pattern is not also limited to be the continuous linear toner image. A pattern such as a dot-like pattern and a chevron pattern which have been proposed since the past may be appropriately employed.

The respective phase positions of one round of the image carrier are desirable to have a constant phase angular distance. However, a dividing number is not limited to be 36. While it is preferable to increase the dividing number in that it permits precision setting, it is not preferable in that it increases a load of operations. It is unnecessary to equalize sampling time intervals of the color shift inspecting pattern and switching time intervals of corrections during printing. It is also possible to increase correction switching timings by performing an interpolation operation of less sampling data. The correction switching timings may be reduced in contrary.

The correction values of the write beginning position and the image magnification are not limited to those in a numerical table. That is, a function may be prepared and may be calculated every time. The correction of the image magnification is not limited to insertion/deletion of a piece of pixels. The image magnification may be corrected by changing frequency of an image clock.

The image forming apparatus of the invention may be carried out regardless of types of a monochrome or full-color, a sheet type, a recording medium conveying type, or an intermediate transfer type, a toner image forming type, or transferring type. The invention can be carried out in the image forming apparatus of various uses such as a printer, various printing machines, a copier, a facsimile, a multi-function printer, and the like by adding necessary units, equipments and a casing structure.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiments of the present invention, and by a method performed by the computer of the system or apparatus by, for example, reading out and executing the computer executable instructions from the storage medium to perform the functions of one or more of the above-described embodiments. The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blue-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-029571, filed on Feb. 19, 2013, which is hereby incorporated by reference herein in its entirety.

What is claimed is:

1. An image forming apparatus, comprising:
an image carrier;
an exposure unit configured to form an electrostatic image by performing scanning exposure of a laser beam to the image carrier;
a developing unit configured to develop the electrostatic image and to form a toner image on the image carrier;
a plurality of support rotating bodies;
a belt member being in contact with the image carrier by being stretched by the plurality of support rotating bodies such that the toner image can be transferred to the belt member from the image carrier;
a first detection portion detecting a position of the toner image transferred to one end portion of the belt member in a direction orthogonal to a moving direction of the belt member;
a second detection portion detecting a position of the toner image transferred to another end portion of the belt member in the direction orthogonal to the moving direction of the belt member;
a third detection portion detecting a position of the toner image transferred to a center portion of the belt member in the direction orthogonal to the moving direction of the belt member; and
a control portion configured to prepare exposure control information correcting an exposure position in a main scanning direction which is a scanning direction of the laser beam per phase position in a sub-scanning direction which is a rotation direction of the image carrier, the control portion having a measuring mode of forming misregistration inspecting toner images at both end portions and a center portion of the image carrier by controlling the exposure unit and the developing unit, of transferring the misregistration inspecting toner images to the belt member, and of detecting the misregistration inspecting toner images by the first, second and third detection portions to obtain position information in the main scanning direction per each phase position in the sub-scanning direction, and preparing the exposure control information from detection results of the first and second detection portions in which an axial moving amount within a rotation cycle of the image carrier is removed on a basis of a detection result of the third detection portion in the measuring mode.

2. The image forming apparatus according to claim 1, wherein the control portion subtracts the detection result of the third detection portion respectively from the detection results of the first and second detection portions per each phase position in the sub-scanning direction of the image carrier to remove the axial moving amount of the rotation cycle of the image carrier.

3. The image forming apparatus according to claim 2, wherein each of the misregistration inspecting toner images is a linear toner image continuous in the sub-scanning direction and developed from the electrostatic image formed by the exposure unit irradiating the laser beam at a predetermined coordinate position in the main-scanning direction for a plurality of times of rotation of the image carrier.

4. The image forming apparatus according to claim 3, wherein the misregistration inspecting toner image detected by the third detection portion is formed at a position on the image carrier where an incident angle of the laser beam to a main scanning line on a virtual exposure surface which is set as a position to be exposed to the exposure unit is 90 degree.

5. The image forming apparatus according to claim 4, wherein the misregistration inspecting toner images detected by the first and second detection portions are formed at positions on the image carrier corresponding to edges of a maximum image width of the virtual exposure surface of the exposure unit.

6. The image forming apparatus according to claim 2, wherein the exposure control information is a table of data specifying an expansion/contraction ratio in the main scanning direction of an image and a position in the main scanning direction of the image per each phase position in the sub-scanning direction in which the scanning exposure is performed on the image carrier.

7. The image forming apparatus according to claim 5, wherein the exposure control information is a table of data specifying an expansion/contraction ratio in the main scanning direction of an image and a position in the main scanning direction of the image per each phase position in the sub-scanning direction in which the scanning exposure is performed on the image carrier.

8. The image forming apparatus according to claim 1, further comprising a second image carrier disposed along the rotation direction of the belt member together with the image carrier as a first image carrier;
wherein misregistration inspecting toner images are formed at both end portions and a center portion of the second image carrier while shifting coordinate positions in the main scanning direction from the first image carrier;
wherein each misregistration inspecting toner image formed on the second image carrier is transferred to the belt member such that the misregistration inspecting toner image is arrayed in parallel in the main scanning direction with the misregistration inspecting toner image formed on the first image carrier; and
wherein the first through third detection portions simultaneously detect the respective misregistration inspecting toner images formed on the both end portions and the center portion of the first and second image carriers and transferred to the belt member.

9. The image forming apparatus according to claim 1, wherein a predetermined circumferential speed difference is set between the image carrier and the belt member.

10. The image forming apparatus according to claim 7, wherein a predetermined circumferential speed difference is set between the image carrier and the belt member.
